(19) United States
(12) Patent Application Publication
(10) Pub. No.: US 2017/0048812 A1
(43) Pub. Date: Feb. 16, 2017

(54) METHODS, APPARATUSES AND SYSTEMS FOR ENHANCING MEASUREMENT GAP IN ASYNCHRONOUS NETWORKS

(71) Applicant: Alcatel-Lucent USA Inc., Murray Hill, NJ (US)

(72) Inventor: Ren DA, Warren, NJ (US)

(21) Appl. No.: 14/826,696

(22) Filed: Aug. 14, 2015

(51) Int. Cl. H04W 56/00

(52) U.S. Cl. CPC H04W 56/004; H04W 56/001; H04W 56/0065

(57) ABSTRACT

In one example embodiment, a method includes coordinating, by a serving base station, transmission times between the serving base station and at least one additional base station, each of the transmission times being a time at which one or more of the serving base station and the at least one additional base station transmit a corresponding first synchronization signal and a corresponding second synchronization signal to a user terminal served by the serving base station. The method further includes determining a measurement gap for the user equipment based on a corresponding transmission time of the serving base station, the measurement gap being a period of time during which the user equipment searches for and measures the first and second synchronization signals by the serving base station and the at least one additional base station, and assigning the determined measurement gap to the user equipment in order for the user equipment to detect and measure synchronization signals transmitted by at least one of the serving base station and the at least one additional base station.

### BACKGROUND

In communication networks such as Long Term Evolution (LTE) networks (e.g., LTE Evolved Universal Terrestrial Access Network (E-UTRAN) networks), a measurement gap length is defined for a user equipment (UE) to identify and measure signals from base stations associated with carriers other than the carrier associated with a base station currently servicing the UE. Such signals may or may not be transmitted on a different frequency channel than a frequency channel on which the UE communicates with the base station that currently serves the UE. This process may be referred to as identifying and measuring inter-frequency and/or inter-radio access technology (RAT) cells based on measuring system synchronization signals.

According to the current standard as defined in 3GPP TS 136.133 V12.7.0 (2015-03), a UE is configured with one of the two measurement gap patterns: either with measurement gap repetition periods (MGRPs) of 40 ms or with MGRPs of 80 ms. During a given MGRP and for duration equal to a measurement gap length, the UE may perform the above identifying and measuring for inter-frequency and/or inter-RAT cells. The measurement gap length is set to 6 ms (i.e., 6 subframes). The main reason for setting the measurement gap length to 6 ms is that the periodicity of synchronization signals (e.g., primary synchronization signal (PSS) and secondary synchronization signals (SSS)) to be searched by the UE, is 5 ms. The measurement gap length of 6 ms accounts for the periodicity of the PSS/SSS as well as additional time (e.g., few hundreds of microseconds) for the UE to perform tasks such as radio frequency (RF) tuning, switch from one frequency to another at the beginning or end of the measurement gap, etc.

During the measurement gap length, the UE cannot transmit any data and is not expected to tune its receiver on any of the E-UTRAN carrier frequencies used by the base station currently serving the UE. Therefore, for the duration of the measurement gap length, the interruption on data transmission between the UE and the base station serving the UE is at least 6 ms out of every 40 ms or every 80 ms, depending on the measurement gap pattern configuration. However, in reality the interruption on the data transmission experienced by the UE may extend beyond the above described measurement gap length. Accordingly, reduction in the measurement gap length will reduce the negative impact thereof on data transmission and UE measurement performance.

In synchronous LTE systems, given that various base stations of such system are synchronized, the timing at which the PSS/SSS signal is transmitted by each base station is known by a base station currently serving the UE and thus the measurement gap length may be reduced from 6 ms to, for example, 1-2 ms.

In contrast to synchronous LTE systems, in asynchronous LTE systems, the base stations are not synchronizing (e.g., timing of transmission of radio subframes carrying PSS/SSS by each base station is not synchronized and not known to the serving base station). Therefore, the timings at which the PSS/SSS signal is transmitted by each base station are not coordinated. Due to lack of synchronization in asynchronous LTE systems, using the method for reducing the measurement gap length in synchronous LTE systems, may not provide the desired reduction in the measurement gap length in asynchronous LTE systems.

### SUMMARY

At least one example embodiment relates to a method for determining, in asynchronous LTE systems, a length and timing of a measurement gap for a user equipment to search for synchronization signals transmitted from base stations other than the base station currently serving the user equipment.

In one example embodiment, a method includes coordinating, by a serving base station, transmission times between the serving base station and at least one additional base station, each of the transmission times being a time at which one or more of the serving base station and the at least one additional base station transmit a corresponding first synchronization signal and a corresponding second synchronization signal to a user terminal served by the serving base station. The method further includes determining a measurement gap for the user equipment based on a corresponding transmission time of the serving base station, the measurement gap being a period of time during which the user equipment searches for and measures the first and second synchronization signals by the serving base station and the at least one additional base station, and assigning the determined measurement gap to the user equipment in order for the user equipment to detect and measure synchronization signals transmitted by at least one of the serving base station and the at least one additional base station.

In yet another example embodiment, the coordinating includes transmitting a message by the serving base station to the at least one additional base station, the message providing the at least one additional base station with the corresponding transmission time of the serving base station.

In yet another example embodiment, the transmitting transmits the message prior to the serving base station transmitting the corresponding first synchronization signal and the corresponding second synchronization signal.

In yet another example embodiment, the transmitting transmits the message through an X2AP interface between the serving base station and any of the at least one additional base station.

In yet another example embodiment, the coordinating coordinates the transmission times based on a common reference point.

In yet another example embodiment, the common reference point is at least one of the corresponding transmission time of the serving base station and a point in time at which the at least one additional base station receives the message.

In yet another example embodiment, the coordinating coordinates the transmission times such that a maximum time difference between any two of the transmission times is 1 milisecond (1 ms).

In yet another example embodiment, the determining determines the measurement gap centered around a corresponding transmission time of the serving base station, and such that the user equipment is able to detect and measure the corresponding first synchronization signal and the corresponding second synchronization signal of the serving base station and the at least one additional base station within the measurement gap.

In yet another example embodiment, the determining determines the measurement gap based on an amount of time for the user equipment to perform radio frequency tuning and complete preparation for performing the search and measurement of the first and second synchronization signals.

In yet another example embodiment, the first synchronization signal is a primary synchronization signal (PSS), the second synchronization signal is a secondary synchronization signal (SSS), and the serving base station and the at least one additional base station are part of an asynchronous Long Term Evolution (LTE) network.

In one example embodiment, a serving base station currently serving a user terminal includes a processor. The processor is configured to coordinate transmission times between the serving base station and at least one additional base station, each of the transmission times being a time at which one or more of the serving base station and the at least one additional base station transmit a corresponding first synchronization signal and a corresponding second synchronization signal to the user terminal. The processor is further configured to determine a measurement gap for the user equipment based on a corresponding transmission time of the serving base station, the measurement gap being a period of time during which the user equipment searches for and measures the first and second synchronization signals by the serving base station and the at least one additional base station, and assign the determined measurement gap to the user equipment in order for the user equipment to detect and measure synchronization signals transmitted by at least one of the serving base station and the at least one additional base station.

In yet another example embodiment, the processor is configured to coordinate the transmission times by transmitting a message by the serving base station to the at least one additional base station, the message providing the at least one additional base station with the corresponding transmission time of the serving base station.

In yet another example embodiment, the processor is configured to transmit the message prior to the serving base station transmitting the corresponding first synchronization signal and the corresponding second synchronization signal.

In yet another example embodiment, the processor is configured to transmit the message through an X2AP interface between the serving base station and any of the at least one additional base station.

In yet another example embodiment, the processor is configured to coordinate the transmission times based on a common reference point.

In yet another example embodiment, the common reference point is at least one of the corresponding transmission time of the serving base station, and a point in time at which the at least one additional base station receives the message.

In yet another example embodiment, the processor is configured to coordinate the transmission times such that a maximum time difference between any two of the transmission times is 1 milisecond (1 ms).

In yet another example embodiment, the processor is configured to determine the measurement gap centered around a corresponding transmission time of the serving base station, and such that the user equipment is able to detect and measure the corresponding first synchronization signal and the corresponding second synchronization signal of the serving base station and the at least one additional base station within the measurement gap.

In yet another example embodiment, the processor is configured to determine the measurement gap based on an amount of time for the user equipment to perform radio frequency tuning and complete preparation for performing the search and measurement of the first and second synchronization signals.

In yet another example embodiment, the first synchronization signal is a primary synchronization signal (PSS), the second synchronization signal is a secondary synchronization signal (SSS), and the serving base station and the at least one additional base station are part of an asynchronous Long Term Evolution (LTE) network.

### BRIEF DESCRIPTION OF THE DRAWINGS

Example embodiments will become more appreciable through the detailed description given herein below and the accompanying drawings, wherein like elements are represented by like reference numerals, which are given by way of illustration only and thus are not limiting, in which:

FIG. 1 illustrates a communication system, according to an example embodiment;

FIG. 2 illustrates a method of reducing a measurement gap, according to an example embodiment;

FIG. 3 illustrates the coordination among base stations for transmission of PSS/SSS, according to one example embodiment;

FIG. 4 illustrates the structure of a base station shown in FIG. 1, according to an example embodiment; and

FIG. 5 illustrates the structure of a UE shown in FIG. 1, according to an example embodiment.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION OF EXAMPLE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

While example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Example embodiments may be utilized in conjunction with RANs such as: Universal Mobile Telecommunications System (UMTS); Global System for Mobile communications (GSM); Advance Mobile Phone Service (AMPS) system; the Narrowband AMPS system (NAMPS); the Total Access Communications System (TACS); the Personal Digital Cellular (PDC) system; the United States Digital Cellular (USDC) system; the code division multiple access (CDMA) system described in EIA/TIA IS-95; a High Rate Packet Data (HRPD) system, Worldwide Interoperability for Microwave Access (WiMAX); Ultra Mobile Broadband (UMB); and 3^{th} Generation Partnership Project LTE (3GPP LTE).

As described in the Background Section, a UE may be configured with a measurement gap length within a MGRP (e.g., 6 ms within a MGRP of 40 ms or 80 ms). Throughout the disclosure, the measurement gap length may also be referred to as simply the measurement gap. During the 6 ms measurement gap, data transmission between the UE and a base station serving the UE is interrupted. As described in the Background Section, during each measurement gap, the effective length of interruption in data transmission extends beyond the duration of the measurement gap itself.

According to the applicable standards, the measurement gap length is set at 6 ms according to Table 8.1.2.1-1 in 3GPP TS 36.133, V12.7.0 (2015-03) Release 12; “E-UTRA: Requirements For Support of Radio Resource Management”. The reason for selecting the measurement gap length of 6 ms is that the periodicity of LTE primary synchronization signal (PSS) and the secondary synchronization signal (SSS) is 5 ms, and the UE performs blind inter-frequency search for the PSS/SSS, i.e., searching for PSS/SSS from another frequency channel associated with another base station (may hereinafter be referred to as a neighboring base station). For performing the blind inter-frequency PSS/SSS search, the UE has at least a 5 ms search window in order to guarantee one PSS/SSS subframe falling into the search window. The 6 ms gap length accounts for the 5 ms searching window and 1 ms additional time for the UE to perform radio frequency (RF) switching between the frequency channel associated with a base station that currently serves the UE and another frequency channel associated with another base station.

The PSS/SSS are synchronization signals transmitted by the neighboring base station and detectable by the UE. PSS/SSS may be included as symbols in one or more radio subframes to be transmitted by a base station to a UE. Before a UE is to switch to a neighboring geographical cell served by a base station that operates on a different carrier frequency than the base station with which the UE currently communicates, the UE searches for and detects the PSS/SSS (during an interval equal to the measurement gap length) transmitted by the neighboring base station, obtains the appropriate network information for the new geographical cell and thereafter switches to (may also be referred to as camp on) the new geographical cell. During a period equal to the measurement gap length, the UE identifies and measures the PSS/SSS.

Example embodiments described hereinafter, provide a shorter measurement gap length and as a result reduce the interruption in data transmission for a UE due to the length of the measurement gap.

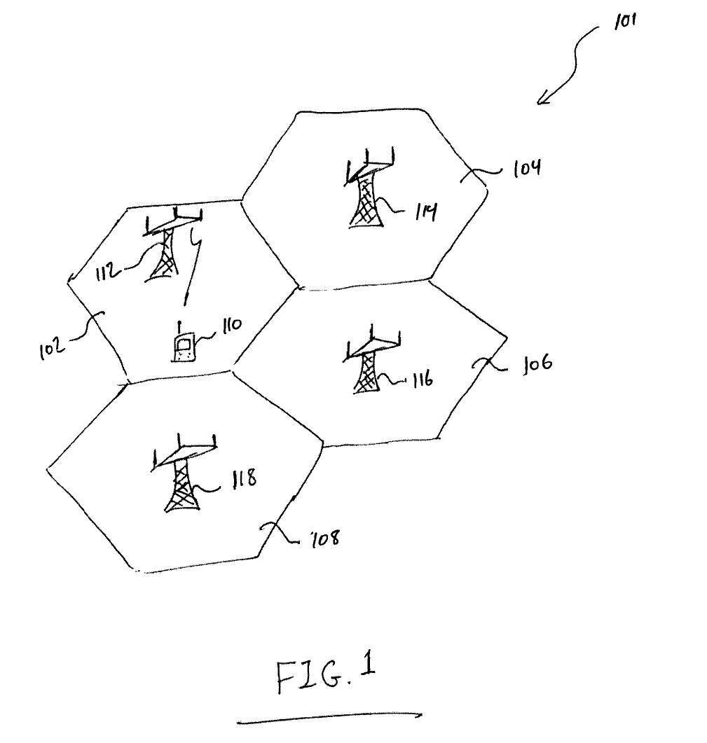

FIG. 1 illustrates a communication system, according to an example embodiment. As shown in FIG. 1, a system 101 may be a communication network. The communication network 101 may be a wireless communication network. In one example embodiment, the communication network 101 is an asynchronous LTE wireless communication network, in which the timing of transmission of radio subframes by different base stations (in a given geographical cell or in neighboring geographical cells) is not synchronized. However, the communication network 101 may be any other type of asynchronous communication network that transmits asynchronized downlink/uplink signals.

The communication network 101 may have a variety of geographical cells such as geographical cells 102, 104, 106 and 108. Each of the geographical cells 102, 104, 106 and 108 may have one or more BSs associated therewith that generally provide wireless services within the geographical cell. As shown in FIG. 1, the geographical cell 102 has the BS 112 associated therewith. The geographical cell 104 has the BS 114 associated therewith. The geographical cell 106 has the BS 116 associated therewith and the geographical cell 108 has the BS 118 associated therewith.

Each of the BSs 112, 114, 116 and 118 may be an e-NodeB, a small cell base station or any other type of base station that is compatible with or used for wireless communication in the communication network 101. Furthermore, each of the geographical cells 102, 104, 106 and 108 may have more than one base station present therein (for example, an e-Node B as well as small cell base stations). Accordingly, while example embodiments may be described with reference to two base stations each serving a different geographical cell (e.g., BS 112 and BS 118), example embodiments are equally applicable to two different base stations operating within the same geographical cell (e.g., BS 112 and a small cell base station operating within the geographical cell 102).

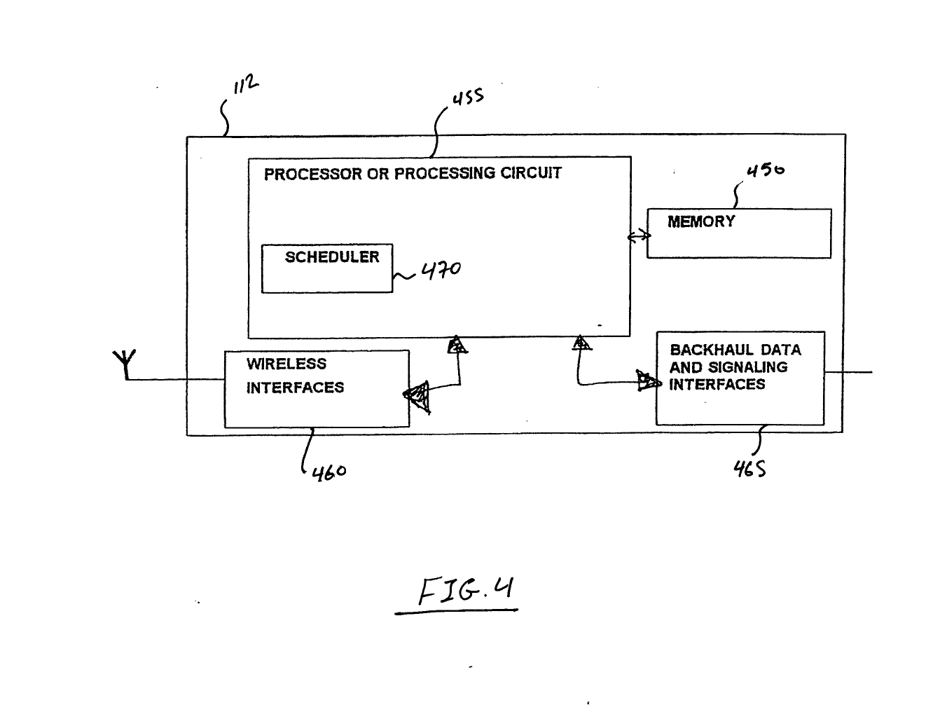

There may be one or more UEs 110 in geographical cell 102 that communicate with the BS 112. The UE 110 may be any type of device capable of establishing communication with the BS 112 including, but not limited to, a cellular phone, a PDA, a tablet, a computer, etc. The number of geographical cells, base stations and UEs of a communication network are not limited to that shown in FIG. 4 but may include any number of geographical cells, base stations and UEs.

The UE 110 may communicate with the BS 112 over a given frequency channel. However, as the UE 110 moves around within the geographical cell 102, close to boundaries of neighboring geographical cells (e.g., geographical cells 104, 106 or 108 in FIG. 4), or moves from one geographical cell to another, the UE 110 may be able to switch geographical cells and communicate with the BS(s) of the neighboring geographical cells (or alternatively, other base stations in the geographical cell 102). Accordingly, the UE 110 may periodically search for and identify other base stations to which the UE 110 can switch from the BS 112 that currently serves the UE 110 (e.g., base stations that belong to another carrier that is different from the carrier associated with the BS 112 currently serving the UE 110). As described above, before the UE 110 is able to switch to (e.g., camp on) any other one of the geographical cells 104, 106 or 108, the UE 110 detects and measures the PSS/SSS transmitted by one or more of the BSs 114, 116 or 118 of the geographical cells 104, 106 or 108, respectively.

Furthermore, a given base station may serve different sectors in a given geographical cell. The base station may serve each of the different sectors by operating on different carrier frequencies. Example embodiments are also applicable to situations in which a UE, such as the UE 110, moves from one sector to another sector in a given geographical cell and thus switches from one carrier frequency on which the UE 110 is currently served by the serving BS 112 in one sector, to another carrier frequency on which the UE 110 is to be served by the serving BS 112 in the new sector.

Furthermore, because the communication network 101 is an asynchronized LTE communication network, the timings of the BS 112, BS 114, BS 116 and BS 118 are not synchronized (e.g., the timing of transmission of radio frames to and from the BS 112, BS 114, BS 116 and/or BS 118) and each of the BS 112, BS 114, BS 116 and BS 118 is unaware of the timing at which the other ones of the BS 112, BS 114, BS 116 and BS 118 transmit a corresponding PSS/SSS. Accordingly, a base station that currently serves a UE (e.g., BS 112 that currently serves the UE 110) is unaware of the timing at which each of the BS 114, BS 116 or BS 118 transmit their corresponding PSS/SSS.

Example embodiments provide methods and systems for enabling coordination among the different base stations regarding the timing of transmission of respective PSS/SSS by the neighboring base stations (e.g., BS 112, BS 114, BS 116 and/or BS 118). As a result, the serving base station (e.g., BS 112) may then configure the UE 110 with a measurement gap length that is shorter than the conventional fixed measurement gap (e.g., 6 ms) but yet is sufficiently large enough to guarantee, or at least expect, that during the measurement gap the UE 110 will be able to detect and measure PSS/SSS transmitted by the serving as well as neighboring base stations (e.g., BS 112 as well as one or more of the BS 114, BS 116 and/or BS 118). Accordingly, the measurement gap length may be shortened and the interruption in data transmission for the UE 110 may be reduced.

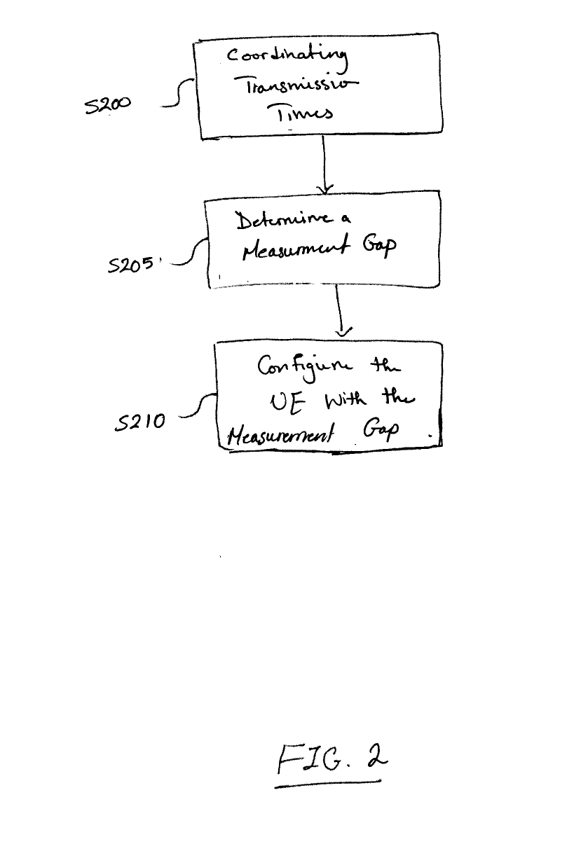

FIG. 2 illustrates a method of reducing a measurement gap, according to an example embodiment.

With reference to FIGS. 1 and 2, at S200 and assuming that the UE 110 is currently being served by the BS 112, the BS 112 coordinates transmission times with one or more neighboring base stations (e.g., BS 114, BS 116 and/or BS 118). The transmission times refer to the time of transmission of a corresponding PSS/SSS by each of the BS 112, BS 114, BS 116 and/or BS 118. The BS 112 may coordinate the transmission times as follows.

In one example embodiment, the serving BS 112 may inform the neighboring base stations (e.g., available neighboring base stations) of the timing at which the serving BS 112 transmits BS 112 it's PSS/SSS (radio subframes that include the PSS/SSS) to the UEs, including UE 110, currently served by the serving BS 112.

In one example embodiment, the serving BS 112 may inform the neighboring base stations by sending a notification message to all the neighboring base stations (e.g., BS 114, BS 116 and/or BS 118) in order to indicate to the neighboring base stations the time at which the BS 112 is going to transmit the corresponding PSS/SSS. In one example embodiment, the serving BS 112 may send the notification message immediately prior to the time at which the BS 112 is scheduled to transmit the corresponding PSS/SSS.

In one example embodiment, the notification message may be exchanged between the serving BS 112 and the neighboring base stations (BS 114, BS 116 and BS 118) via X2AP interface, as defined in 3GPP TS 36.423 V13.0.0 (2015-06) Release 13; “E-UTRA: Requirements For Support of Radio Resource Management”, sections 5-7.

By sending the notification message to the neighboring base stations, the serving BS 112 requests the neighboring base stations to adjust the transmission of their corresponding PSS/SSS based on a common reference point. In one example embodiment, the common reference point is the time at which the neighboring base stations receive the notification message from the serving BS 112.

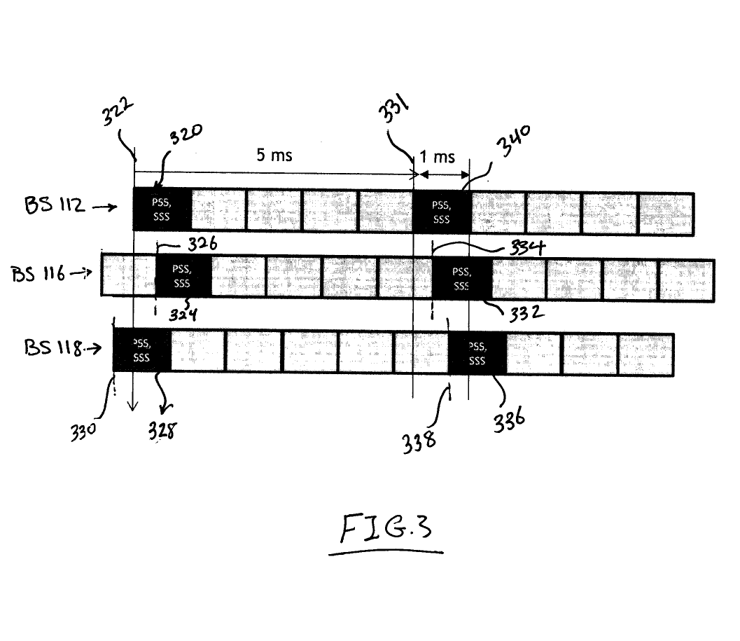

In the example embodiment described above, the serving BS 112 may transmit the notification message immediately before transmitting the corresponding PSS/SSS. Accordingly, by adjusting (adjusting may be used synonymously with coordinating and synchronizing) their respective transmission time based on the common reference point (time of receiving the notification message), each of the neighboring base stations may adjust their next corresponding PSS/SSS to be transmitted in a subframe 5 ms after the time at which the notification is received from the serving base station 112. The adjusting of the PSS/SSS based on the notification message sent by the serving BS 112 will be illustrated below with reference to FIG. 3.

FIG. 3 illustrates the coordination among base stations for transmission of PSS/SSS, according to one example embodiment.

As shown in FIG. 3, the serving BS 112 has a corresponding PSS/SSS subframe 320 scheduled to be transmitted at point 322, the neighboring BS 116 has a corresponding PSS/SSS subframe 324 scheduled to be transmitted at point 326 and the neighboring BS 118 has a corresponding PSS/SSS subframe 328 scheduled to be transmitted at point 330. In one example embodiment, the serving BS 112 transmits the notification message to the neighboring BS 116 and the neighboring BS 118 immediately before the transmission of the PSS/SSS subframe 320 by the BS 112 (e.g., at the point 320). Accordingly, the base stations (e.g., the BS 116 and/or the BS 118) receiving the notification message from the BS 112, wait for a period of time to pass from the point of time at which the notification message was received (e.g., wait for 5 ms from the point 322). Thereafter, the BS 116 and the BS 118 re-start the periodic transmission of corresponding PSS/SSS from the subframe within 1 ms from the end of the wait period, where the end of the waiting period is the point 331 shown in FIG. 3, which is 5 ms from the point 322.

For example, the neighboring BS 116 waits for 5 ms from the point 322 and then restarts the periodic transmission of PSS/SSS subframe 334 within 1 ms from the point 331 (e.g., at point 334). Similarly, the neighboring BS 118 waits for 5 ms from the point 322 and then re-starts the periodic transmission of PSS/SSS subframe 336 within 1 ms from the point 331 (e.g., at point 338). Accordingly and as shown in FIG. 3, the transmission of the next PSS/SSS subframe by each of the serving BS 112 and the neighboring BSs 116 and 118 (i.e., PSS/SSS subframes 332, 336 and 340) are synchronized such that each of the PSS/SSS subframes is transmitted within 1 ms of any other ones of the PSS/SSS subframes transmitted by the other ones of the serving BS 112 and/or the neighboring BSs 116 and/or 118. In other words, any two of the PSS/SSS subframes 332, 336 and 340 are scheduled to be transmitted within 1 ms of one another. The duration of transmission of a PSS/SSS subframe is assumed to be 1 ms as shown in FIG. 3.

Generally, clocks of base stations are relatively stable. Therefore, in one example embodiment, the coordination of the transmission times (e.g., through the transmission of the notification message by the serving BS 112) is performed infrequently (e.g., once every month for macro cell base stations, once every few days for small cell base stations, etc.)

Referring back to FIG. 2 and upon coordinating the transmission times at S200, at S205, the serving BS 112 determines a measurement gap for the UE 110. In one example embodiment, the serving BS 112 determines the measurement gap to be shorter than the conventional fixed measurement gap (e.g., 6 ms) but wide enough in order to ensure, or at least expect, detection and measurement of PSS/SSS transmitted by the serving BS 112, neighboring BS 116 and/or neighboring BS 118. Accordingly, in one example embodiment the BS 112 determines the measurement gap to be equal to 3 ms.

The measurement gap may be determined based on empirical studies. Factors that may be taken into account for determining the measurement gap include, but are not limited to, the maximum difference between the coordinated transmission times (e.g., 1 ms as discussed in the example embodiment above), the time for the UE 110 to detect and measure the PSS/SSS transmitted by the serving BS 112 and the neighboring BSs 116 and 118, and the amount of time for the UE 110 to perform RF tuning (cell detection, as known in the art), as discussed above. In one example embodiment and based on empirical studies, the maximum amount of time for the UE 110 to perform RF tuning is set to 0.5 ms.

In one example embodiment, the BS 112 centers the 3 ms measurement gap around the transmission of the PSS/SSS subframe 340 of the serving BS 112 since the UE 110 is synchronized with the serving BS 112. Accordingly, centering the measurement gap around the PSS/SSS subframe of the serving BS 112 and given the maximum of 1 ms difference between the coordinated transmission times of the PSS/SSS by the serving BS 112 and the neighboring BSs 116 and 118, the measurement gap of 3 ms provides sufficiently long window for the UE 110 to detect and measure transmitted PSS/SSS as well as perform RF tuning by the UE 110.

In one example embodiment, for UEs with legacy design (which may be unable to complete the preparation for and measurement of PSS/SSS within the 3 ms measurement gap), the BS 112 may configure such UEs with a 4 ms measurement gap. UEs with legacy design may be known in advance to the serving BS 112 via, for example, higher level signaling between the UEs and the serving BS 112.

Upon determining the measurement gap, the BS 112 may configure (assign to) the UE 110 with the determined measurement gap in order for the UE to perform the underlying measurement of PSS/SSS during the shortened measurement gap (compared to the conventional fixed measurement gap) in every MGRP (which may be set to 40 ms or 80 ms, as discussed above). The serving BS 112 may configure the UE 110 with the determined measurement gap, according to known and/or to be developed methods by which a serving base station may configure a served BS with a measurement gap.

In performing the functions described above with reference to FIGS. 1-3, the BS 112 (as well as any of the other BSs 114, 116 and 118), may be equipped with a memory and a processor. FIG. 4 illustrates the structure of a base station shown in FIG. 1, according to an example embodiment.

Referring to BS 112 (as a representative of the BSs of the communication network 101 shown in FIG. 1), FIG. 4 illustrates that the BS 112 includes a memory 450, a processor 455, a wireless communication interfaces 460, a backhaul data and signaling interfaces (referred to herein as backhaul interface) 465 and a scheduler 470. The processor or processing circuit 455 controls the function of the BS 112 and is operatively coupled to the memory 450 and the communication interfaces 460. While only one processor 455 is shown in FIG. 4, it should be understood that multiple processors may be included in a typical base station (eNB), such as the BS 112. The functions (i.e., functions described above with respect to FIGS. 1-3) performed by the processor 455 may be implemented using hardware.

As discussed above, such hardware may include one or more Central Processing Units (CPUs), digital signal processors (DSPs), application-specific-integrated-circuits, field programmable gate arrays (FPGAs) computers or the like. The term processor or processing circuit, used throughout this document, may refer to any of these example implementations, though the term is not limited to these examples.

Still referring to FIG. 4, the wireless communication interfaces 460 (also referred to as communication interfaces 460) include various interfaces including one or more transmitters/receivers (or transceivers) connected to one or more antennas to wirelessly transmit/receive control and data signals to/from devices communicating with the BS 112, including but not limited to, the UE 110 as shown in FIG. 1.

The backhaul interface 465 interfaces with other components (not shown) of the communication network 100 including, but not limited to, a serving gateway (SGW), a mobility management entity (MME), other eNBs, or other Evolved Packet Core (EPC) network elements and/or radio access network (RAN) elements within an IP Packet Data Network (IP-CAN).

The memory 450 may buffer and store data that is being processed at BS 112, transmitted and received to and from the BS 112. The memory 450 may have computer-readable instructions stored therein. The processor 455 is configured to execute the computer readable instructions stored on the memory 450, thus effectively converting the processor 455 into a special-purpose processor that enables the BS 112 to perform the functions described above.

Still referring to FIG. 4, the scheduler 470 schedules control and data communications that are to be transmitted and received by the BS 112 to and from devices communicating with the BS 112, including but not limited to, the UE 110 as shown in FIG. 1.

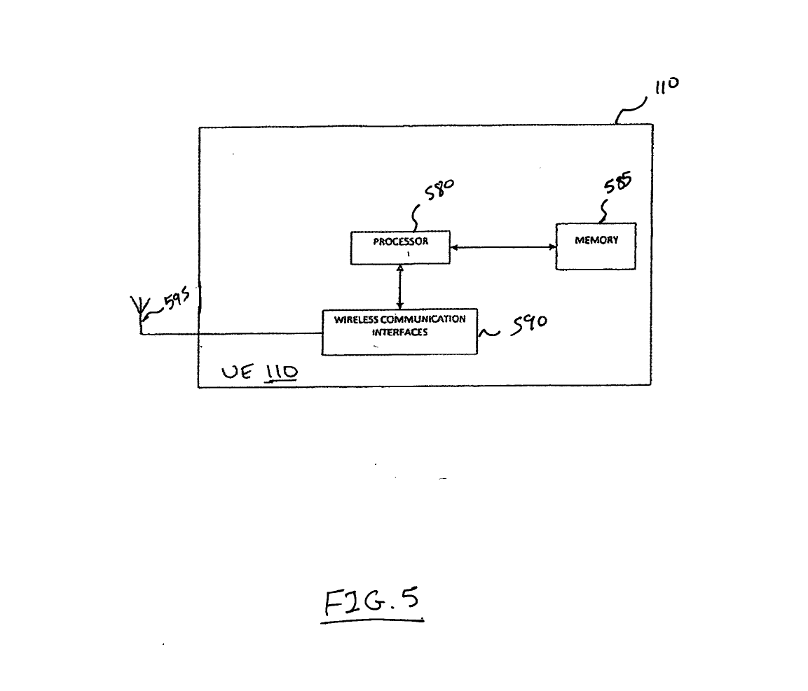

The UE 110 may be equipped with a memory and a processor. FIG. 5 illustrates the structure of a UE shown in FIG. 1, according to an example embodiment.

Referring to FIG. 5, the UE 110 includes a memory 580, a processor (or processing circuit) 585 connected to the memory 580, various wireless communication interfaces 590 (hereinafter may also be referred to as various interfaces 590) connected to the processor 580, and an antenna 595 connected to the various interfaces 590. The various interfaces 590 and the antenna 595 may constitute a transceiver for transmitting/receiving data from/to the BS 112 and/or any other device/component communication with the UE 110.

The memory 585 may be a computer readable storage medium that generally includes a random access memory (RAM), read only memory (ROM), and/or a permanent mass storage device, such as a disk drive. The memory 585 also stores an operating system and any other routines/modules/applications for providing the functionalities of the UE 110 (e.g., functionalities of a UE, methods according to the example embodiments, etc.) to be executed by the processor 580. These software components may also be loaded from a separate computer readable storage medium into the memory 585 using a drive mechanism (not shown). Such separate computer readable storage medium may include a disc, tape, DVD/CD-ROM drive, memory card, or other like computer readable storage medium (not shown). In some example embodiments, software components may be loaded into the memory 585 via one of the various interfaces 590, rather than via a computer readable storage medium.

The processor 580 is configured to execute the computer readable instructions stored on the memory 585, thus effectively converting the processor 580 into a special-purpose processor that enables the UE 110 to perform the functions described above.

The various interfaces 590 may include components that interface the processor 580 with the antenna 595, or other input/output components. As will be understood, the interfaces 590 and programs stored in the memory 585 to set forth the special purpose functionalities of the UE 110 will vary depending on the implementation of the UE 110.

While certain components of the UE 110 are shown in FIG. 5 and described above, the components of the UE 110 is not limited thereto and may vary depending on the implementation of the UE 110. The UE 110 may include any other known and/or to be developed components for carrying out functionalities of the UE 110.

As described above with reference to FIG. 2, coordinating the transmission times of the PSS/SSS by serving and neighboring base stations and subsequently determining the timing and the duration of the measurement gap based thereon, results in a shorter duration of the measurement gap length compared to measurement gap with which UEs are presently configured (e.g., measurement gap of 3 ms or 4 ms compared to the current measurement gap of 6 ms). Consequently, the effect of the measurement gap on interrupting the data transmission between UEs and their serving BSs may be reduced.

Example embodiments being thus described, it will be obvious that the same may be varied in many ways. For example, specific numeral examples are used to designate the MGRPs, measurement gap lengths, etc., in order to describe the inventive concepts. However, the inventive concepts are not limited to the provided numerical examples. Such variations are not to be regarded as a departure from the spirit and scope of example embodiments, and all such modifications as would be obvious to one skilled in the art are intended to be included within the scope of the claims.

1. A method comprising:
coordinating, by a serving base station, transmission times between the serving base station and at least one additional base station, each of the transmission times being a time at which one or more of the serving base station and the at least one additional base station transmit a corresponding first synchronization signal and a corresponding second synchronization signal to a user terminal served by the serving base station;
determining a measurement gap for the user equipment based on a corresponding transmission time of the serving base station, the measurement gap being a period of time during which the user equipment searches for and measures the first and second synchronization signals by the serving base station and the at least one additional base station; and
assigning the determined measurement gap to the user equipment in order for the user equipment to detect and measure synchronization signals transmitted by at least one of the serving base station and the at least one additional base station.

2. The method of claim 1, wherein the coordinating includes transmitting a message by the serving base station to the at least one additional base station, the message providing the at least one additional base station with the corresponding transmission time of the serving base station.

3. The method of claim 2, wherein the transmitting transmits the message prior to the serving base station transmitting the corresponding first synchronization signal and the corresponding second synchronization signal.

4. The method of claim 2, wherein the transmitting transmits the message through an X2AP interface between the serving base station and any of the at least one additional base station.

5. The method of claim 2, wherein the coordinating coordinates the transmission times based on a common reference point.

6. The method of claim 5, wherein the common reference point is at least one of,
the corresponding transmission time of the serving base station, and
a point in time at which the at least one additional base station receives the message.

7. The method of claim 1, wherein the coordinating coordinates the transmission times such that a maximum time difference between any two of the transmission times is 1 milisecond (1 ms).

8. The method of claim 1, wherein the determining determines the measurement gap centered around a corresponding transmission time of the serving base station, and such that the user equipment is able to detect and measure the corresponding first synchronization signal and the corresponding second synchronization signal of the serving base station and the at least one additional base station within the measurement gap.

9. The method of claim 8, wherein the determining determines the measurement gap based on an amount of time for the user equipment to perform radio frequency tuning and complete preparation for performing the search and measurement of the first and second synchronization signals.

10. The method of claim 1, wherein
the first synchronization signal is a primary synchronization signal (PSS),
the second synchronization signal is a secondary synchronization signal (SSS), and
the serving base station and the at least one additional base station are part of an asynchronous Long Term Evolution (LTE) network.

11. A serving base station currently serving a user terminal, the serving base station comprising:
a processor configured to,
coordinate transmission times between the serving base station and at least one additional base station, each of the transmission times being a time at which one or more of the serving base station and the at least one additional base station transmit a corresponding first synchronization signal and a corresponding second synchronization signal to the user terminal;
determine a measurement gap for the user equipment based on a corresponding transmission time of the serving base station, the measurement gap being a period of time during which the user equipment searches for and measures the first and second synchronization signals by the serving base station and the at least one additional base station; and
assign the determined measurement gap to the user equipment in order for the user equipment to detect and measure synchronization signals transmitted by at least one of the serving base station and the at least one additional base station.

12. The serving base station of claim 11, wherein the processor is configured to coordinate the transmission times by transmitting a message by the serving base station to the at least one additional base station, the message providing the at least one additional base station with the corresponding transmission time of the serving base station.

13. The serving base station of claim 12, wherein the processor is configured to transmit the message prior to the serving base station transmitting the corresponding first synchronization signal and the corresponding second synchronization signal.

14. The serving base station of claim 12, wherein the processor is configured to transmit the message through an X2AP interface between the serving base station and any of the at least one additional base station.

15. The serving base station of claim 12, wherein the processor is configured to coordinate the transmission times based on a common reference point.

16. The serving base station of claim 15, wherein the common reference point is at least one of,
the corresponding transmission time of the serving base station, and
a point in time at which the at least one additional base station receives the message.

17. The serving base station of claim 11, wherein the processor is configured to coordinate the transmission times such that a maximum time difference between any two of the transmission times is 1 milisecond (1 ms).

18. The serving base station of claim 11, wherein the processor is configured to determine the measurement gap centered around a corresponding transmission time of the serving base station, and such that the user equipment is able to detect and measure the corresponding first synchronization signal and the corresponding second synchronization signal of the serving base station and the at least one additional base station within the measurement gap.

19. The serving base station of claim 18, wherein the processor is configured to determine the measurement gap based on an amount of time for the user equipment to perform radio frequency tuning and complete preparation for performing the search and measurement of the first and second synchronization signals.

20. The serving base station of claim 1, wherein
the first synchronization signal is a primary synchronization signal (PSS),
the second synchronization signal is a secondary synchronization signal (SSS), and
the serving base station and the at least one additional base station are part of an asynchronous Long Term Evolution (LTE) network.
